(19) United States
(12) Patent Application Publication
(10) Pub. No.: US 2013/0330043 A1
(43) Pub. Date: Dec. 12, 2013

(54) Ladder Rack Enclosure

(71) Applicants: Kent Goldsmith, Wyckoff, NJ (US); Joshua E. Taylor, Dewitt, NY (US)

(72) Inventors: Kent Goldsmith, Wyckoff, NJ (US); Joshua E. Taylor, Dewitt, NY (US)

(73) Assignee: CABLExpress, Syracuse, NY (US)

(21) Appl. No.: 13/494,628

(22) Filed: Jun. 12, 2012

(51) Int. Cl. F16L 3/08; G02B 6/00; G02B 6/38; H02B 1/20

(52) U.S. Cl. 385/70; 248/58; 361/828; 439/49; 385/135

(57) ABSTRACT

A cable management device that hangs downward an overhead cable conveyance, such as a ladder rack or cable tray. The cable management device includes an enclosure chamber and a patch board. Spare runs of cable can be stored, out of sight and out of the way, in the enclosure chamber. the patch board allows cable connections to be made at the juncture where a cable “pays off” of its overhead conveyance, before heading downwards to a component rack extending upwards from the floor of the data center. Also, a flipper wiring path trunk assembly, for a set of 12 optical signals, with LC duplex modules and LC connectors.

### BACKGROUND OF THE INVENTION

1. Field of the Invention

The present invention relates to electronics and/or optics facilities and more particularly to data centers including electric and/or optical cable, and even more particularly to data centers having ladder rack(s) spaced above component racks for guiding and constraining cables within a climate controlled data center system.

2. Description of the Related Art

Before turning to the relevant background art of data centers and ladder rack, it is noted that the “ladder racks” discussed herein relate to ladder racks of the type that is used to direct, guide and secure cabling (e.g., electrical cables, fiber optic cables). There are other kinds of “ladder racks” (see, for example, US patent application 2007/0108351 (“351 Gatta”)), but these devices are used to hold ladders (that is, ladders for construction workers to climb) and are not considered to be relevant, germane and/or analogous to the data center “ladder racks” which will be discussed herein. More specifically, it is believed that conventional climbing ladders (as in 351 Gatta) have not, and would not, be used to replace “ladder racks” in a data center. Conversely, it is also believed that ladder racks, of the type used in a data center, are not suitable for use as climbing type ladders. Accordingly, 351 Gatta is considered to be highly non-analogous and irrelevant technology despite the superficial similarity caused by the use of the term “ladder rack.”

Data centers with “overhead conveyance hardware” are known. Two types of overhead conveyance hardware used to secure and guide cables in a data

center are: (i) a “ladder rack”; and (ii) a basket tray (or cable tray).

U.S. Pat. No. 8,072,780 (“780 Roy,” Figure numbers and reference numerals set forth in this paragraph will refer to 780 Roy, rather than the present document) discloses a data center that includes overhead conveyance hardware in the form of ladder racks for guiding and securing cabling. More specifically, ladder racks 610, 620, 630, 640, 650 are shown in FIGS. 2A to 2C of 780 Roy. Note how the ladder racks of 780 Roy define a length direction (the length direction of the ladder), a transverse direction (the direction of extension of the rungs of the ladder) and a pay-off direction, which is generally the vertical and downwards direction. Cables run along the length direction of the ladder supported by the rungs and or lateral members of the ladder structure. Usually the ladder racks are located and/or oriented to be: (i) well away from the floor of the data center; (ii) near the ceiling of the data center; and (iii) oriented so that the length-direction/transverse-direction plane defined by the ladder rack member is substantially parallel to the ceiling. At the correct location, a given cable will be supported by the overhead conveyance until it reaches a location that is spaced well above a component rack that is the intended destination of one of the ends of the cable. Therefore, at the location of the component rack, the given cable is allowed to run off of the overhead conveyance in the downwards, vertical direction and that cable will run down to its intended component rack. It is noted that multiple cables will generally run down to a single component rack. It is further noted that not all component racks have the same height. It is further noted that not all overhead conveyance structures are located at the same vertical height above the floor of the data center. What all of this means is that the vertical distance between the overhead conveyance structure and the top of a given component rack will vary on a case-by-case basis.

Basket trays will now be discussed. US patent application 2010/0278500 (“500 Campos,” Figure numbers and reference numerals set forth in this paragraph will refer to 500 Campos, rather than the present document) discloses a basket tray 14. (See 500 Campos at ABSTRACT.) At paragraph 00004, 500 Campos discloses that basket trays may be mounted overhead in a data center (that is, the basket tray of 500 Campos may be used as a form of overhead conveyance hardware). As shown in FIGS. 1 and 2 of 500 Campos, the Campos device further includes mounting hardware 16, 20 so that a component rack 10 for holding fiber optic components (not shown). To put it in other, more simple, words, 500 Campos hangs a component rack from the bottom of its overhead conveyance structure (specifically a basket tray. In this way, the cables run in a quite direct manner from the 500 Campos overhead conveyance structure down into its intended component rack 10. 500 Campos discloses that its hanging fiber optic equipment rack 10 can be used to save floor space in a data center. (See 500 Campos at paragraph 00005.) However, the solution of 500 Campos has some strong drawbacks, at least with respect to application of its technology in certain applications. One drawback is that the component rack will now be located at a vertical direction high above the floor, which will be generally difficult (or even impossible) for data center workers to reach from a position standing on the floor of the data center. Another drawback is that the conventional overhead conveyance structures will likely not reliably support the weight of component racks that are substantially heavier than component rack 10 of 500 Campos (and it is further noted that most component racks are much larger than component rack 10 of 500 Campos). More specifically: (i) a large and heavy component rack will put much stress and/or strain on the basket tray 14 of 500 Campos and on the hardware 16 used to connect the component rack of 500 Campos to its basket tray, meaning that the hardware could fail if a heavy component rack were substituted for the small and light component rack 10 of 500 Campos; and (ii) even to the extent that a large component rack can be supported by 500 Campos, such a component rack is likely to move (that is, swing or sway slightly) because it is not fixed to the floor of the data center.

The following published documents may also include helpful background information: US patent application (“USPA”) 2011/0074117 (“117 Caveney”); USPA 20110211329 APPARATUS AND METHOD FOR ORGANIZING CABLES IN A CABINET; USPA 20110211328 APPARATUS AND METHOD FOR ORGANIZING CABLES IN A CABINET; USPA 20100322583 High Density and Bandwidth Fiber Optic Apparatuses and Related Equipment and Methods; USPA 20100322582 High Capacity Fiber Optic Connection Infrastructure Apparatus; USPA 20100322581 High Fiber Optic Cable Packing Density Apparatus; USPA 20100322579 HIGH-DENSITY FIBER OPTIC MODULES AND MODULE HOUSINGS AND RELATED EQUIPMENT; USPA 20100322576 Fiber Optic Module Assembly Having Improved Finger Access and Labeling Indicia; USPA 20100322562 Optical Interconnection Assemblies and Systems for High-Speed Data-Rate Optical Transport Systems; USPA 20100322554 OPTICAL INTERCONNECTION METHODS FOR HIGH-SPEED DATA-RATE OPTICAL TRANSPORT SYSTEMS; USPA 20100278500 Mounting Assembly for Fiber Optic Equipment; USPA 20100195955 OPTICAL FIBER INTERCONNECTION DEVICES AND SYSTEMS USING SAME; USPA 20100098428 Optical interconnection modules for hybrid electrical-optical networks; USPA 20090273915 APPARATUS AND METHOD FOR ORGANIZING CABLES IN A CABINET; USPA 20090180737 OPTICAL FIBER INTERCONNECTION DEVICES AND SYSTEMS USING SAME; USPA 20090067800 Fiber optic adapter module and tray; USPA 20080131067 PRE-CONNECTORIZED FIBER OPTIC CABLE NETWORK INTERCONNECTION APPARATUS; USPA 20070047897 Fiber optic universal bracket apparatus and methods; USPA 20050207709 Optical polarity modules and systems; USPA 20040184741 Optical polarity modules and systems; U.S. Pat. No. (“USP”) 8,009,959 Optical interconnection methods for high-speed data-rate optical transport systems; U.S. Pat. No. 7,974,105 Apparatus and method for organizing cables in a cabinet; U.S. Pat. No. 7,756,371 Optical fiber interconnection devices and systems using same; U.S. Pat. No. 7,689,079 Optical fiber interconnection devices and systems using same; U.S. Pat. No. 7,391,952 Pre-connectorized fiber optic cable network interconnection apparatus; U.S. Pat. No. 7,330,629 Fiber optic universal bracket apparatus and methods; U.S. Pat. No. 6,869,227 Optical polarity modules and systems; and/or U.S. Pat. No. 6,758,600 Optical polarity modules and systems.

Description of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

According to the present invention, instead of moving the component rack up to its associated overhead conveyance structure, an enclosure is provided in order to (at least substantially) enclose the cable(s) during the entire length of their pay-off run from the overhead conveyance structure (for example, a ladder rack) all the way down to an entry into a component rack (for example, a simple aperture in the top wall of the component rack). The present invention is directed to a cabling system that may include an overhead conveyance structure, an enclosure chamber structure and overhead connection hardware for mechanically connecting the enclosure chamber structure to the overhead conveyance structure so that that the enclosure chamber structure hangs downwards from the overhead conveyance structure. The overhead conveyance structure is structured: (i) to guide cable(s); and (ii) to be mechanically connectable to a ceiling structure (see DEFINITIONS section), such as the beams of a drop ceiling. In some preferred embodiments, the overhead conveyance structure is one of the following: a ladder rack, or an overhead cable tray. The enclosure chamber structure defines an interior space suitable for enclosing the cable(s) as it/they run from the overhead conveyance structure down to the component rack. Also, in some embodiments the enclosure rack may additionally be used to accommodate spare runs of cables (for example, fiber optic cables, electrical cables).

Some preferred embodiments of the present invention further include a patch board sub-assembly that is located within the interior space of enclosure chamber structure. In some preferred embodiments, the patch board will include at least one fiber optic cable connection structure. In some preferred embodiments, the patch board is oriented so that it will be inclined at an angle (for example, a 45 degree angle) when the system of the present invention is installed in a data center. Also, in embodiments with a patch board inside the enclosure chamber structure, the enclosure chamber may include an access door structure that can be moved between an open and closed position.

While some embodiments of the present invention are directed entirely to the enclosure structure (and connecting hardware) itself, other preferred embodiments of the present invention will further include an optical and/or electrical component rack (for example, a 23 inch standard rack, a 19 inch standard rack, a non-standard rack) located directly below the patch board so that cables can be run in a space efficient manner between the patch board and the rack located below the patch board. In some embodiments of the present invention, the cable enclosure structure further include a telescoping cable management channel structure, with the cable management channel structure defining an interior space to accommodate the cable runs located between a component rack and either: (i) the overhead conveyance structure; or (ii) non telescoping portions of the enclosure chamber structure (such as a patch board enclosing portion. In these embodiments, the cable management channel portion of the enclosure structure is structured to telescope so that the channel has some length adjustability to accommodate variation in the vertical length between the component rack entry and the overhead conveyance structure for the various component racks and various overhead conveyance structures of various data centers. In some embodiments, the chamber enclosure structure of the present invention will include a funnel portion which is wider at its top end (that is, its overhead conveyance structure end) than it is at its lower end (that is, its component rack end).

Various embodiments of the present invention may exhibit one or more of the following objects, features and/or advantages:

(i) provides for a multimedia patch panel that is both reasonably out-of-the-way and reasonably accessible at the same time;

(ii) mounts directly to overhead conveyance for added space in the data center;

(iii) the enclosure chamber prevents physical interference with the cables in the vertical space between the component rack and the overhead conveyance structure;

(iv) facilitates compliance with applicable data center regulations (such as, for example TIA-942);

(v) improved aesthetics by reducing or eliminating exposed runs of cable in the vertical space between the component rack entry and the associated overhead conveyance structure;

(vi) less time required to configure and/or reconfigure data center due to increased cable manageability;

(vii) keeps signal loss (or dB loss) to a minimum due to efficient cable management;

(viii) frees up valuable component rack space because spare runs of cable can now be stored in the enclosure chamber instead of the component rack if desired;

(ix) saves space in the data center, which can be especially advantageous when the data center is climate controlled (as they generally are);

(x) one person mounting;

(xi) can hold both copper and fiber cables (as well as any other type of data communication cable (of specific types now known or to be developed in the future); and

(xii) in embodiments with a patch board, the use of the patch board connections at the juncture between the overhead support structure (for example, the ladder rack) and the component rack, it becomes easier to switch in and out: (a) components in the component rack, (b) an entire component rack, and/or (c) overhead-run portions of cables that lead to components in the component racks.

According to a first aspect of the present invention, there is a cabling system for use in a space having an overhead conveyance structure, an associated component rack and a set of cables, including at least one cable. the set of cable(s) runs from the overhead conveyance structure down to the component rack. the system includes: an enclosure structure; and an overhead connection hardware set. The overhead connection hardware set mechanically connects the enclosure structure to the overhead conveyance member. The enclosure structure defines an interior space that is of a suitable size and shape so that, when the system is installed in the space, a portion of the set of cables that runs from the overhead conveyance structure to the associated component rack will be at least substantially enclosed within the interior space of the enclosure structure.

A further aspect of the present invention is shown at FIG. 13. This aspect includes both the assembly of hardware shown in FIG. 13, as well as any and all methods for making this assembly.

According to a further aspect of the present invention, there is a cabling system for use in a space having a ceiling structure. the system includes: an overhead conveyance member; a ceiling connection hardware set; a patch board structure including a plurality of cable connector hardware sets; and an overhead connection hardware set. The ceiling connection hardware set is mechanically connected to the overhead conveyance member. The ceiling connection hardware set is structured, sized, shaped, located and/or connected to mechanically connect the overhead conveyance structure to the ceiling structure. The overhead connection hardware set mechanically connects the patch board structure to the overhead conveyance member. According to a further aspect of the present invention, there is a cabling system for use in a space having a ceiling structure. The system includes: an overhead conveyance member; a ceiling connection hardware set; an enclosure structure; an overhead connection hardware set; and a patch board structure. The ceiling connection hardware set is mechanically connected to the overhead conveyance member. The ceiling connection hardware set is structured, sized, shaped, located and/or connected to mechanically connect the overhead conveyance structure to the ceiling structure. The overhead connection structure mechanically connects the enclosure structure to the overhead conveyance member. The enclosure structure defines an interior space that is of a suitable size, shape and accessibility for holding cables. The patch board structure is located at least substantially within the interior space of the enclosure structure.

### BRIEF DESCRIPTION OF THE DRAWINGS

The present invention will be more fully understood and appreciated by reading the following Detailed Description in conjunction with the accompanying drawings, in which:

FIG. 1 is a schematic view of a first embodiment of a cabling system for a data center according to the according to the present invention;

FIG. 2 is an orthographic, partially cut away, front view of a second embodiment of a cabling system for a data center according to the according to the present invention;

FIG. 3 is an orthographic top view of a portion of the second embodiment system;

FIG. 4 is a perspective view of a third embodiment of a cabling system for a data center according to the according to the present invention;

FIG. 5 is an embodiment of a patch cable front panel suitable for use in the third embodiment system;

FIG. 6 is another embodiment of a patch cable front panel suitable for use in the third embodiment system;

FIG. 7 is an orthographic, side, partially cut away view of a portion of the third embodiment system;

FIG. 8 is an orthographic front view of a portion of the third embodiment system;

FIG. 9 is an orthographic, front, partially cut away view of a fourth embodiment of a cabling system according to the present invention;

FIG. 10 is an orthographic top view of a portion of the third embodiment cabling system;

FIG. 11 is a perspective view of another portion of the third embodiment system;

FIG. 12 is a perspective view of another portion of the third embodiment system; and

FIG. 13 is a schematic view of a flipper wiring path trunk method and associated pattern according to the present invention.

### DETAILED DESCRIPTION OF THE INVENTION

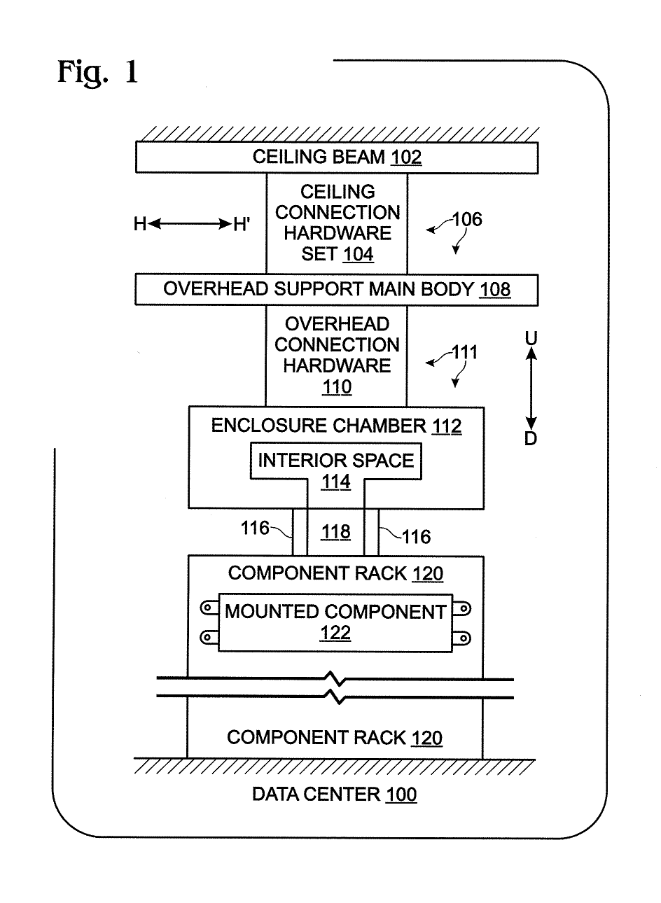

FIG. 1 shows a data center 100 including: ceiling beam 102; overhead conveyance sub-assembly 106 (including ceiling connection hardware set 104 and overhead conveyance main body 108; an enclosure chamber sub-assembly 111; component rack 120; first mounted component 122; horizontal directions H and H′ and vertical direction U/D (that is, up/down). As those of skill in the art will appreciate, there is often more than one component in a single rack. Enclosure chamber structure 111 includes: overhead connection hardware set 110; main enclosure chamber portion 112 (defining interior space 114); and telescoping enclosure chamber portion 116 (defining interior space 118). Although it is not necessarily apparent from the schematic view of FIG. 1, the top of the main enclosure chamber is located to abut, or at least be very close to, the bottom of overhead support main body 108. In this way, the cable(s) (not shown) that run from the overhead conveyance structure down to the component rack will be substantially completely enclosed in the vertical space between the component rack and the overhead conveyance structure.

The enclosure chamber is mechanically connected (see DEFINITIONS section) to the overhead conveyance main body by overhead connection hardware 110. The overhead connection hardware may be any type of suitable mechanical connection of any type now known, or to be developed in the future. In some embodiments, the mechanical connection of the overhead connection hardware will be substantially rigid, while in other embodiments, the enclosure chamber may have some degrees of freedom of motion relative to the overhead conveyance, so long as the overhead conveyance supports the enclosure chamber against the forces of gravity. In some embodiments, the mechanical connection of the overhead connection hardware set will detachably attachable. For example, a detachable mechanical connection may be formed by using bolts, nuts and/or washers as the overhead connection hardware set. In other embodiments, the mechanical connection of the overhead connection hardware set may be relatively permanent. An example of this would be a welded mechanical connection.

Spare runs of cable can be stored in the interior space of the enclosure chamber. In this way, the spare runs of cable: (i) are held up overhead and out of the way; (ii) do not take up space in the component rack; (iii) do not take up space in the overhead support main body itself; and/or (iv) do not get in the way of humans and/or robots that work in the data center.

The various cables used in system 100 (not shown for clarity of illustration) may be any type of data communication cable, now known or to be developed in the future, including, but not limited to, electrical cables and fiber optic cables. As is well-understood in the art, a single cable may include several separate signal communication paths. As is further understood, cables may include other hardware, such as electric field shielding and electrical insulation. It should also be understood that a “cable” may include intermediate cable-to-cable connectors within a run of a single cable. For example, in embodiments with patch boards, a single “cable” will run up from the component rack to an intermediate connector at the patch board and further up to the overhead conveyance structure.

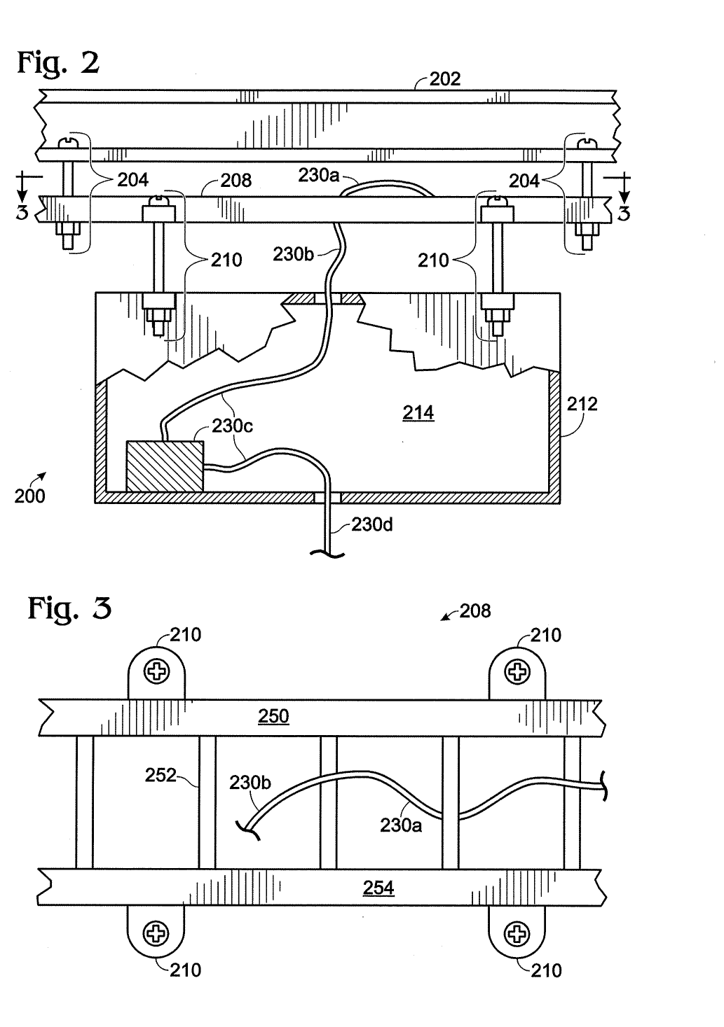

FIGS. 2 and 3 show cabling system 200 including: ceiling I-beam 202; ceiling connection hardware sets 204; overhead conveyance main body 208; overhead connection hardware sets 210; enclosure chamber 212 (including interior space 214); first cable 230 (including overhead cable run 230a, first descending run 230b, spare run 230c and second descending run 230d). Overhead conveyance main body 208 is in the form of a ladder rack and includes elongated members 250, 254 and transverse rung members 252, as shown in FIG. 3. This is not necessarily a preferred embodiment of the present invention, but is presented here primarily to show that there may be some space between the top of the enclosure chamber structure and the bottom of the overhead conveyance structure (see reference numeral 230b) and/or between the bottom of the enclosure chamber and the entry aperture of the component rack (see reference numeral 230d). However, these gaps should be a couple of inches, at most, so that the enclosure chamber encloses substantially the entire run of cable in the vertical space between the overhead conveyance structure and the component rack. In this way, the aesthetic and functional advantages of the enclosure rack of the present invention (as discussed above) may be realized.

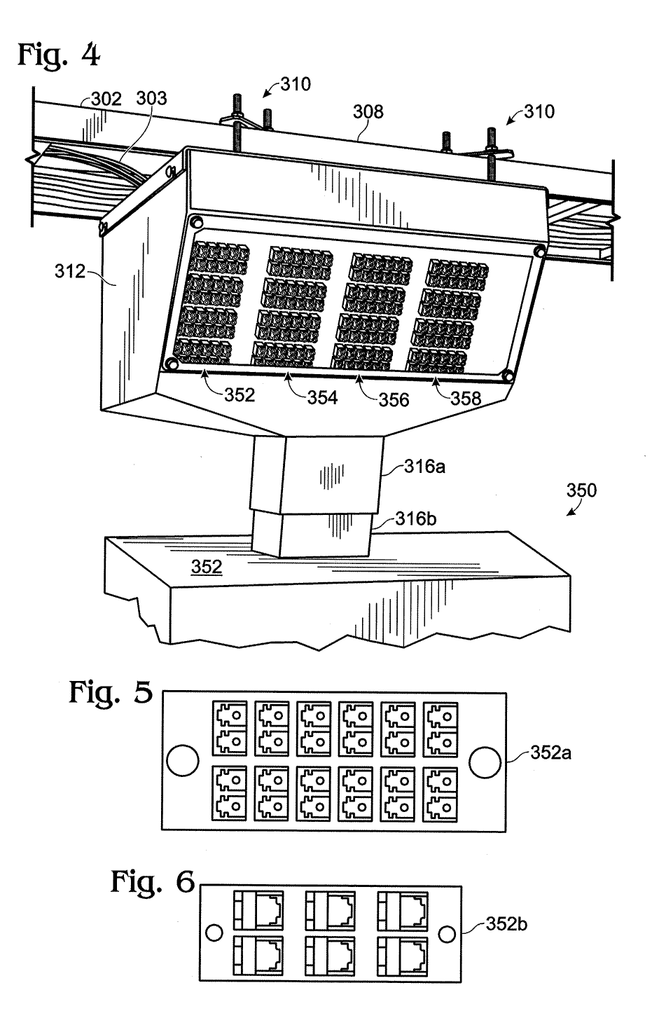

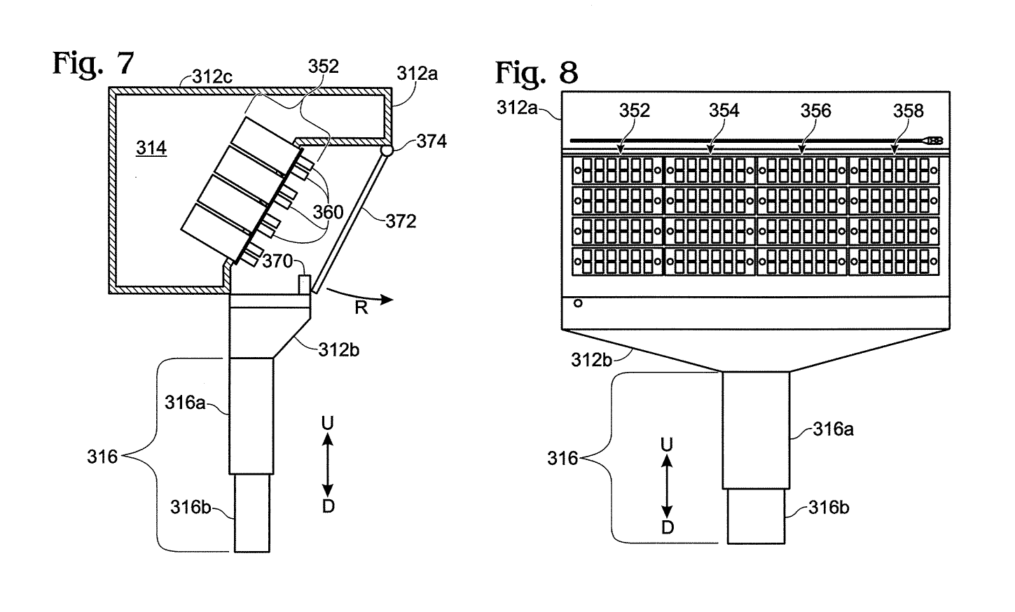

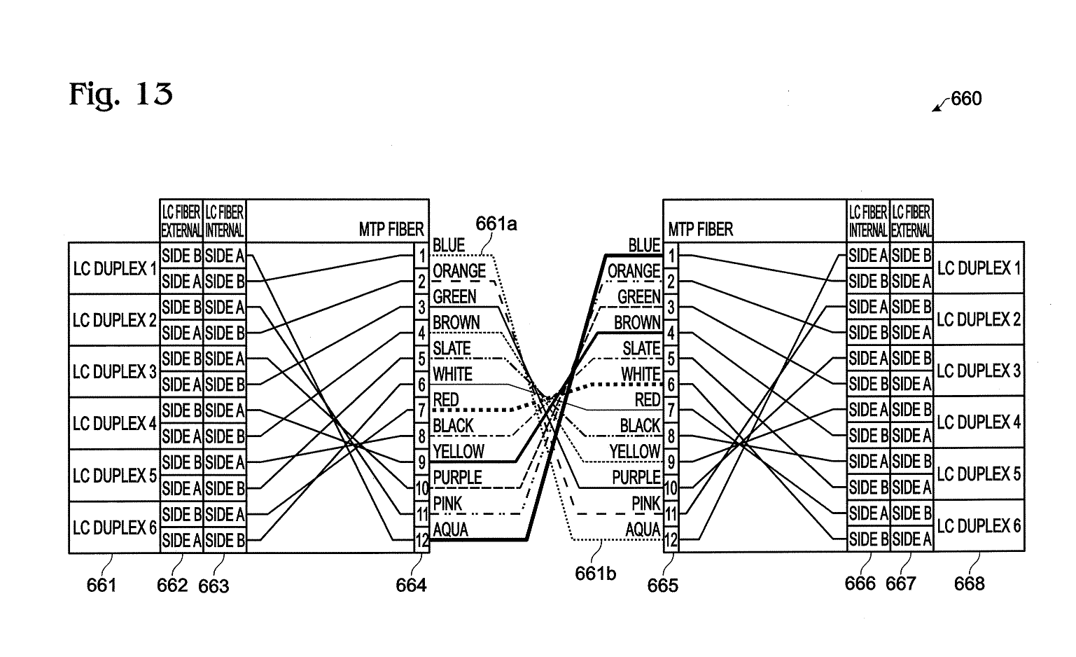

FIGS. 4 to 8 and 10-12 show cabling system 300 including: overhead conveyance main body 308; overhead connection hardware sets 310; enclosure chamber structure 312, 316a, 316b (defining interior space 314); and component rack 350. The enclosure chamber structure includes patch-board-enclosing portion 312; telescoping cable channel 316; patch board modules 352, 354, 356, 358; cable connectors 360; latch assembly 370; door member 372; and hinge member 374. As shown in FIG. 4, enclosure chamber 350 includes top wall 352. As shown in FIGS. 7, 8, 11 and 12, the patch-board-enclosing portion includes front wall 312a; funnel portion 312b; and top wall 312C. As further shown in FIGS. 7 and 8, cable channel 316 includes base section 316a and first telescoping section 316b. As shown in FIGS. 10-12, top wall 312c includes longitudinal (L direction) slots 312e and transverse (T direction) slots 312f. As shown in FIG. 12, a first overhead connection hardware sets 310 includes: first suspension member 310a; first bolt 310b; second bolt 310c; first nut 310d; second nut 310e. As shown in FIG. 12, a second overhead connection hardware sets 310 includes: first suspension member 310f; first bolt 310g; second bolt 310h; first nut 310i; and second nut 310j. It is noted that the patch boards 352, 354, 356 and 358 are all located within the interior space of the enclosure chamber structure (specifically inside main portion 312). In this way, the cables can be efficiiently managed using the spatial layout and/or labelling, which is conventionally provided by a conventional patch board, but this can be accomplished without exposing the cable(s) and/or without taking up space (for example, front panel space) of component rack 316. In preferred embodiments, the cables enter top wall 352 of component 350 rack, but it is possible to make an enclosure rack according to the present invention where the cables enter the component rack through a different side (such as the rear lateral side).

Embodiment 300, when fully populated can hold up to 192 LC duplex ports or 96 copper ports (or a combination of the two). Other embodiments may alternatively include still other styles of connectors (now known or to be developed in the future). Generally speaking, the patch board connector choices of the designer should be made to increase the probability that the right kinds of cables are accommodated in sufficient quantities for a given data center application.

As best shown in FIG. 8, embodiment 300 accepts 16 patch board modules. However, the number of connectors in a patch board module may vary depending upon what type(s) of connector(s) are used on a given patch board module. This can be seen by reviewing FIGS. 5 and 6, which respectively show: (i) a patch board module 352a with 24 connectors of the type LC Duplex, flangeless, stable spring couplers; and (ii) patch board module 352b with 6 connectors of the CAT6 type, loaded with copper jacks. Alternatively, the patch board may not have alternative modules that can be combined, but may instead have a single dedicated and specially-design patch board module.

Embodiment 300 is constructed primarily from lightweight aluminum with a durable powder coat finish to enhance durability and/or aesthetics.

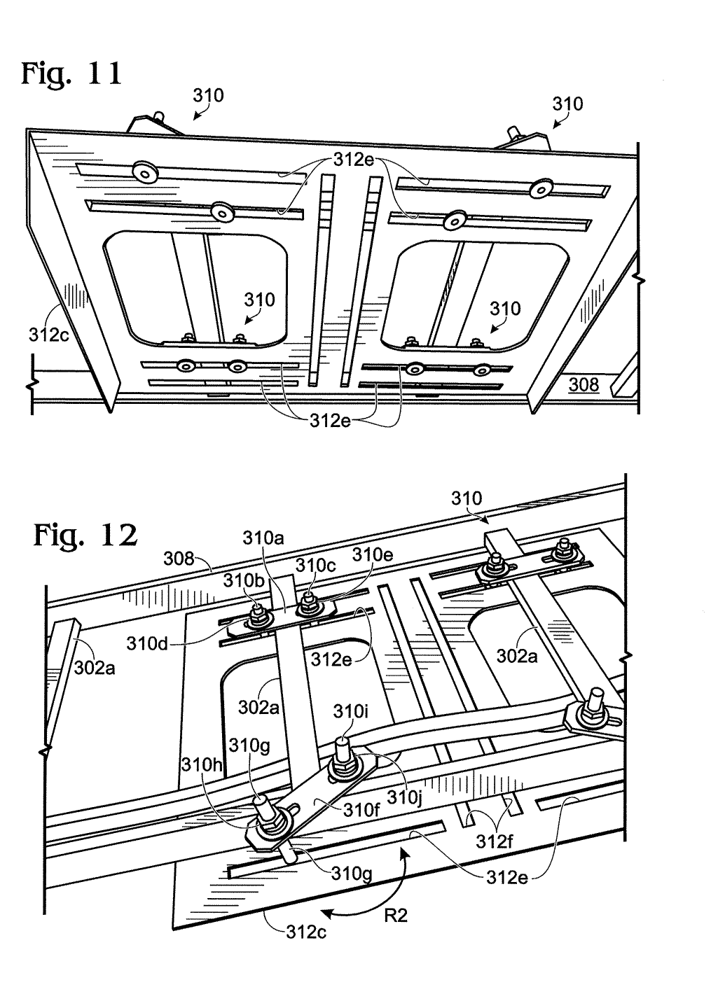

The overhead connection hardware set 310, especially as shown in FIGS. 11 and 12, will now be discussed. First, it is noted that each overhead connection hardware set 310 does not rigidly mechanically connect to the ladder rack. Rather, each hardware set 310 forms a sort of loop, extending upwardly from top wall 312c, and made up of two bolts (that is the side walls of the upside down “U” shape) and a suspension member (the base of the generally upside down “U” shape). As best shown in FIG. 12, these loops are threaded into position so that a portion of the ladder rack (a longitudinal member or rung) is captured inside the loop. In this way, the suspension member will sit on top of a longitudinal member, but will be free to move with respect to the ladder rack, at least so long as the ladder rack remains captive within the confines of the loop. While there are many degrees of (slight) freedom of motion between the overhead connection hardware set and the ladder rack, the enclosure will not tend to move or shift very much because: (i) the forces of gravity and friction tend to hold the overhead conveyance structure in a constant position; and/or (ii) the enclosure may (or may not) be rigidly connected at the component rack end. On the other hand, this slight motion allows for relative loose tolerance of piece parts and also prevents the enclosure chamber sub-assembly from being stressed and strained due to overconstraint.

FIG. 12 further shows that there is also one (or more) degree(s) of freedom between the overhead connection hardware set 310 and the enclosure chamber structure to which it is mechanically connected. For example, the connection hardware set shown towards the top left corner of FIG. 12 is mechanically connected to the enclosure chamber structure at one of the longitudinal slots 312e. This means that the enclosure chamber structure can be shifted longitudinally relative to its own overhead connection hardware. As shown by the connection hardware set towards the lower left side of FIG. 12, another longitudinal slot 312e allows longitudinal freedom of motion between the hardware connection set and the enclosure chamber. This hardware connection set also allows relative rotation, in the R2 direction between the enclosure chamber and this particular connection hardware set. In a similar vein, other slots (such as the transverse slots of FIG. 10) may be used to otherwise allow for freedom of motion so that stresses and strains can be accommodated without material failure.

As explained in connection with one of the other embodiments, telescoping cable channel can be telescoped to adjust in length in order to reach the top surface of the component rack so that no exposed wires are apparent in the space between the bottom of the enclosure and the top of the component rack (even though it is not known in advance how tall the component rack will be).

Enclosure chamber 312 includes main chamber 312a and funneling chamber 312b. The funneling chamber directs cables from the wide face of the patch board down to a skinny trunk (that is, a compact bunch of exposed cables, or a relatively skinny cable channel filled with cables, such as cable channel 316).

This mixed media (copper and fiber) patch panel is designed to mount directly to the overhead conveyance. In some embodiments of the present invention, there may be a patch board, but no enclosure chamber, although system 300 includes both an enclosure and a patch board.

One potentially inventive feature of system 300 is the openable and cloasble access door that helps enclose the cables in the vicinity of the space directly in front of the patch board (see FIG. 7). This means that: (i) the cables will still be substantially enclosed, when the door is in the closed position, even in the vicinity of the patch board; and (ii) workers can still access the patch board by moving the door to the open position. In the embodiment of FIG. 7, the door rotates between its open and closed positions, in the direction of arrow R, but other types of doors are possible. For example, FIG. 4 shows a variation where the door is in the form of an access panel that can be entirely removed from the enclosure chamber by unfastening threaded connectors. The door may be made of materials that allow the patchboard to be at least partially seen through the door. For example, FIG. 4 shows a door of metal mesh-geometry material (that is a metal panel with a large matrix of apertures in it). As a further example, FIG. 7 shows a transparent material door.

Another potentially inventive feature of system 300 is the angled orientation of the patch board relative to the vertical and horizontal axes. The potential benefits relate primarily to aesthetics and ergonomics. Workers and/or installers have better, more comfortable access to the patch board when it is angled as best shown in FIG. 7.

Embodiment 300 facilitates the use of precision stable spring couplers for optimal performance that can help assure network uptime.

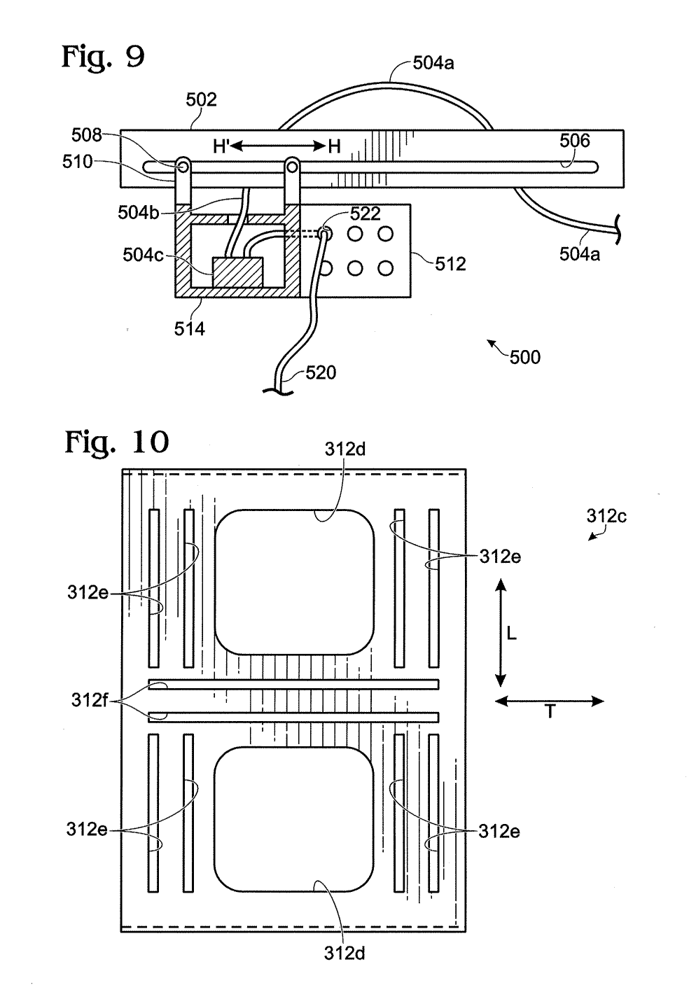

FIG. 9 shows cabling system 500 including: overhead conveyance main body 502; ceiling-side cable 504 (including overhead run 504a, descending run 504b and spare run 504c); overhead connection hardware set 506, 508, 510 (including upwardly extending arm 510, slot 506 and bolt 508); patch board panel 512; enclosure chamber 514; floor-side cable 520; and cable connector assembly 522. Unlike the foregoing embodiments, embodiment 500 does not enclose the cable all the way from the ladder rack down to the top of the component rack. Rather, the embodiment of FIG. 9 is inventive, at least in part, because it features a patch board (that is, cable connector assembly 522) connected to an overhead conveyance structure. This is advantageous because it keeps the patch board out of the way, but still accessible, in embodiments where enclosure of the cables is not desired or required for some reason.

Now some potential applications of rack systems according to the present invention will be discussed. One preferred application and setting for the present invention is what is called a “data center,” which has been discussed before. In the DEFINITIONS sections, the definition of the term “electro-optical component room” includes some types of spaces where the present invention may be used, other than a conventional data center. It should be kept in mind that the concept of a data center and/or electro-optical component room may change over time as computer technology changes. For example, data centers, and other electro optical component rooms may become much smaller. Or they may be more rigorously climate controlled than they are now. Or they may be less rigorously climate controlled than they are now. However, while the specifications of the rooms suitable data centers might change in the future, the present invention is likely to continue to remain useful and/or advantageous because it makes space efficient use of a room, regardless of the scale of the room and the components it contains. For example, it is at least theoretically possible that data centers of the future may be too small for the admission of human beings. Even in these potential “dollhouse data centers” of the future (to coin a phrase), it can be seen that the present invention may still be useful in guiding the teeny tiny data transmission line so that the dollhouse data center is comprehensible, tidy, operational and/or correctly connected up in all of its tiny component racks and tiny “overhead” cable support structures (which will not really be over a head, or at least not over a human worker's head), like teeny tiny ladder racks. This dollhouse embodiment is not currently a preferred embodiment of the present invention, precisely because most data centers are plenty big enough to admit human workers into their interior spaces. But, it may well become a preferred embodiment in the future.

However, it is already contemplated that if and when data centers change in scale or other specification(s), then some embodiments of the present invention may well still be advantageously applicable to those new kinds of electro-optical component rooms. Besides data centers that are much tinier than those of today (as postulated in the previous paragraph), it is also possible that data centers might get much colder (to run the equipment), much hotter (too run the equipment), much more narrow (think of a data center on a long passenger train car), much larger (think of a data center 10 stories high with nine story component racks), much more fragile (think cables that are so thin that they will snap easily), and so on, and so on. While this paragraph is not intended to make specific, concrete predictions about what data centers, and other electro-optical equipment rooms of the future, may look like, it is intended to show that the present inventors already understand that the technology of electro-optical components and/or component racks will likely change over the next couple of decades, and that further that the present invention will likely be easily and directly applicable to many of these new styles and/or designs as they emerge over the course of time.

FIG. 13 shows a wiring method and associated wiring pattern 660 that is an embodiment and aspect of the present invention. In data centers, and/or other types of electro-optical component rooms. More specifically, FIG. 13 shows a set of signal paths as they are “wired” from: (i) first LC duplex structures 661; (ii) to first LC fiber external path portions 662; (iii) to first LC Fiber Internal path portions 663; (iv) to first MTP CONNECTOR fiber path portions 664; (v) to second MTP CONNECTOR path portions 665; (vi) to second LC fiber path portions internal 666; (vii) to second LC duplex external path portions 667; (viii) to second LC duplex structure external interface path portions 668. The labeled colors in FIG. 13 serve to show a novel pattern and method for a flipper wiring path trunk. Alternatively, these flipper wiring path trunks may generally be wired according to a method called “Method D” in the relevant technical art. FIG. 13 does not show Method D, but it shows a different method and different resulting pattern, which is pattern 660 of FIG. 13. Pattern 660, while not the same as Method D wiring pattern, is compatible with the Method D wiring pattern. Generally, a customer will not be able to tell whether its flipper wiring path has been made according to Method D, or pattern 660. It is believed that pattern 660 may have certain logistical and/or functional advantages over Method D. While the wiring method and pattern 660 of FIG. 13 has not been a major focus of this document, it is believed that pattern 660 and/or its associated method of creating pattern 660 is inventive over Method D (while being compatible with Method-D-based systems). Furthermore, wiring pattern 660 may have advantageous and/or suitable applications even in systems that do not include the ladder rack enclosure of the present invention. It is noted that “LC” and “MTP” are terms in the art that are not really used as acronyms, but, rather, as a way of generically identifying types of optical connectors and/or optical fibers. It is further noted that because assembly 660 works as a “flipper” this means that the color associated with a given light path does not remain constant, but, rather, changes to accomplish the flipping, as shown in FIG. 13. For example, the light path 661 is considered as the BLUE signal in the vicinity of reference numeral 661a (and upstream of reference numeral 661a), but becomes considered as the AQUA signal in the vicinity of reference numeral 661b (and downstream of signal 661b). Still, at all points in the flipper assembly: there are twelve separate light paths, and each light path will be unambiguously associated with one of the 12 standard colors (as shown in FIG. 13).

### DEFINITIONS

Any and all published documents mentioned herein shall be considered to be incorporated by reference, in their respective entireties. The following definitions are provided for claim construction purposes:

Electro-optical equipment room: any room that is used primarily to house operational electro-optical equipment; electro-optical equipment rooms include: data centers; telecommunications data centers; internet related data centers; data centers with component racks; data centers without component racks; climate controlled data centers; non-climate controlled data centers; data centers in man-made structures like buildings; data centers is structures present in, or carved from, nature (for example, caves, cavities in glaciers, etc.); data centers big enough to admit humans; data centers too small to admit humans; data centers with robots in them; data centers with no robots in them; clean equipment rooms; dirty equipment rooms; equipment rooms open to the sky; equipment rooms on vehicles like automobiles, trains, trucks, rockets, ships, airplanes and so on; equipment rooms in nuclear reactors; equipment rooms in office buildings; equipment rooms on offshore oil rigs; etc.

Present invention: means “at least some embodiments of the present invention,” and the use of the term “present invention” in connection with some feature described herein shall not mean that all claimed embodiments (see DEFINITIONS section) include the referenced feature(s).

Embodiment: a machine, manufacture, system, method, process and/or composition that may (not must) be within the scope of a present or future patent claim of this patent document; often, an “embodiment” will be within the scope of at least some of the originally filed claims and will also end up being within the scope of at least some of the claims as issued (after the claims have been developed through the process of patent prosecution), but this is not necessarily always the case; for example, an “embodiment” might be covered by neither the originally filed claims, nor the claims as issued, despite the description of the “embodiment” as an “embodiment.”

First, second, third, etc. (“ordinals”): Unless otherwise noted, ordinals only serve to distinguish or identify (e.g., various members of a group); the mere use of ordinals shall not be taken to necessarily imply order (for example, time order, space order).

Electrically Connected: means either directly electrically connected, or indirectly electrically connected, such that intervening elements are present; in an indirect electrical connection, the intervening elements may include inductors and/or transformers.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slid able mechanical connections.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

ceiling structure, includes, but is not limited to, drop ceiling structures including horizontally-oriented i-beams.

Unless otherwise explicitly provided in the claim language, steps in method or process claims need only be performed that they happen to be set forth in the claim only to the extent that impossibility or extreme feasibility problems dictate that the recited step order be used. This broad interpretation with respect to step order is to be used regardless of alternative time ordering (that is, time ordering of the claimed steps that is different than the order of recitation in the claim) is particularly mentioned or discussed in this document. Any step order discussed in the above specification, and/or based upon order of step recitation in a claim, shall be considered as required by a method claim only if: (i) the step order is explicitly set forth in the words of the method claim itself; and/or (ii) it would be substantially impossible to perform the method in a different order. Unless otherwise specified in the method claims themselves, steps may be performed simultaneously or in any sort of temporally overlapping manner. Also, when any sort of time ordering is explicitly set forth in a method claim, the time ordering claim language shall not be taken as an implicit limitation on whether claimed steps are immediately consecutive in time, or as an implicit limitation against intervening steps.

What is claimed is:

1. A cabling system for use in a space having an overhead conveyance structure, an associated component rack and a set of cables, including at least one cable, that runs from the overhead conveyance structure down to the component rack, the system comprising:
an enclosure structure; and
an overhead connection hardware set;
wherein:
the overhead connection hardware set mechanically connects the enclosure structure to the overhead conveyance member; and
the enclosure structure defines an interior space that is of a suitable size and shape so that, when the system is installed in the space, a portion of the set of cables that runs from the overhead conveyance structure to the associated component rack will be at least substantially enclosed within the interior space of the enclosure structure.

2. The system of claim 1 wherein the overhead conveyance member is a ladder rack.

3. The system of claim 1 wherein the overhead connection structure comprises a loop structure that is mechanically connected to the enclosure chamber structure and extends upwardly from the enclosure chamber structure; and
the loop structure is sized, shaped and/or located so that it can be connected around a portion of the overhead conveyance portion so that the overhead connection structure is suspended from the overhead conveyance structure when the system is installed in the space.

4. The system of claim 1 wherein the overhead connection structure mechanically connects the enclosure structure to the overhead conveyance member in a detachably attachable manner.

5. The system of claim 1 wherein the enclosure chamber structure includes a funnel portion.

6. The system of claim 1 further comprising a component rack wherein the enclosure chamber structure includes a telescoping portion that is adjustable in length.

7. A cabling system for use in a space having a ceiling structure, the system comprising:
an overhead conveyance member;
a ceiling connection hardware set;
a patch board structure including a plurality of cable connector hardware sets; and
an overhead connection hardware set;
wherein:
the ceiling connection hardware set is mechanically connected to the overhead conveyance member;
the ceiling connection hardware set is structured, sized, shaped, located and/or connected to mechanically connect the overhead conveyance structure to the ceiling structure; and
the overhead connection hardware set mechanically connects the patch board structure to the overhead conveyance member.

8. The system of claim 7 wherein the overhead conveyance member is a ladder rack.

9. The system of claim 7 wherein:
the ceiling connection structure comprises a plurality of threaded bolts; and
the overhead connection structure comprises a plurality of threaded bolts.

10. The system of claim 7 wherein the patch board structure includes at least one fiber optic cable style connector hardware set.

11. The system of claim 10 wherein the patch board structure includes at least one electrical cable style connector hardware set.

12. The system of claim 7 wherein the patch board structure is generally flat and is supported at an angle relative to the ceiling structure when the system is installed on the ceiling structure.

13. The system of claim 7 wherein the overhead connection structure mechanically connects the patch board structure to the overhead conveyance member in a detachably attachable manner.

14. A cabling system for use in a space having a ceiling structure, the system comprising:
an overhead conveyance member;
a ceiling connection hardware set;
an enclosure structure;
an overhead connection hardware set; and
a patch board structure
wherein:
the ceiling connection hardware set is mechanically connected to the overhead conveyance member;
the ceiling connection hardware set is structured, sized, shaped, located and/or connected to mechanically connect the overhead conveyance structure to the ceiling structure;
the overhead connection structure mechanically connects the enclosure structure to the overhead conveyance member;
the enclosure structure defines an interior space that is of a suitable size, shape and accessibility for holding cables; and
the patch board structure is located at least substantially within the interior space of the enclosure structure.

15. The system of claim 14 wherein the patch board structure includes at least one fiber optic cable style connector hardware set.

16. The system of claim 14 wherein the patch board structure includes at least one electrical cable style connector hardware set.

17. The system of claim 14 wherein the enclosure structure is sized, shaped and/or located to substantially enclose a portion of a cable that runs from the overhead conveyance member down to the component rack.

18. A flipper wiring path trunk assembly for flipping a set of twelve light paths, with the light paths being respectively associated, at any given point, with the following set of twelve colors:
blue;
orange;
green;
brown;
slate;
white;
red;
black;
yellow;
purple;
pink; and
aqua;
the assembly comprising:
a first LC connector;
a connector-to-connector light path hardware set comprising first to twelfth light paths; and
a second LC connector;
wherein:
the first LC connector comprises the following LC fiber internal modules: duplex 1 side a, duplex 1 side b, duplex 2 side a, duplex 2 side b, duplex 3 side a, duplex 3 side b, duplex 4 side a, duplex 4 side b, duplex 5 side a, duplex 5 side b, duplex 6 side a, duplex 6 side b;
the second LC connector comprises the following LC fiber internal modules: duplex 1 side a, duplex 1 side b, duplex 2 side a, duplex 2 side b, duplex 3 side a, duplex 3 side b, duplex 4 side a, duplex 4 side b, duplex 5 side a, duplex 5 side b, duplex 6 side a, duplex 6 side b;
the first LC connector further comprises the following MTP fiber ports: blue, orange, green, brown, slate, white, red, black, yellow, purple, pink and aqua;
the second LC connector further comprises the following MTP fiber ports: blue, orange, green, brown, slate, white, red, black, yellow, purple, pink and aqua;
the first light path of the connector-to-connector light path hardware set optically connects the blue MTP fiber port of the first LC connector to the aqua MTP fiber port of the second LC connector;
the second light path of the connector-to-connector light path hardware set optically connects the orange MTP fiber port of the first LC connector to the pink MTP fiber port of the second LC connector;
the third light path of the connector-to-connector light path hardware set optically connects the green MTP fiber port of the first LC connector to the purple MTP fiber port of the second LC connector;
the fourth light path of the connector-to-connector light path hardware set optically connects the brown MTP fiber port of the first LC connector to the yellow MTP fiber port of the second LC connector;
the fifth light path of the connector-to-connector light path hardware set optically connects the slate MTP fiber port of the first LC connector to the black MTP fiber port of the second LC connector;
the sixth light path of the connector-to-connector light path hardware set optically connects the white MTP fiber port of the first LC connector to the red MTP fiber port of the second LC connector;
the seventh light path of the connector-to-connector light path hardware set optically connects the red MTP fiber port of the first LC connector to the white MTP fiber port of the second LC connector;
the eighth light path of the connector-to-connector light path hardware set optically connects the black MTP fiber port of the first LC connector to the slate MTP fiber port of the second LC connector;
the ninth light path of the connector-to-connector light path hardware set optically connects the yellow MTP fiber port of the first LC connector to the brown MTP fiber port of the second LC connector;
the tenth light path of the connector-to-connector light path hardware set optically connects the purple MTP fiber port of the first LC connector to the green MTP fiber port of the second LC connector;
the eleventh light path of the connector-to-connector light path hardware set optically connects the pink MTP fiber port of the first LC connector to the orange MTP fiber port of the second LC connector;
the twelfth light path of the connector-to-connector light path hardware set optically connects the aqua MTP fiber port of the first LC connector to the blue MTP fiber port of the second LC connector;
the first LC connector further comprises first to twelfth LC internal light paths;
the first internal light path of the first LC connector optically connects LC fiber internal module duplex 1 side a to the aqua MTP port of the first LC connector;
the second internal light path of the first LC connector optically connects LC fiber internal module duplex 1 side b to the blue MTP port of the first LC connector;
the third internal light path of the first LC connector optically connects LC fiber internal module duplex 2 side a to the pink MTP port of the first LC connector;
the fourth internal light path of the first LC connector optically connects LC fiber internal module duplex 2 side b to the orange MTP port of the first LC connector;
the fifth internal light path of the first LC connector optically connects LC fiber internal module duplex 3 side a to the purple MTP port of the first LC connector;
the sixth internal light path of the first LC connector optically connects LC fiber internal module duplex 3 side b to the green MTP port of the first LC connector;
the seventh internal light path of the first LC connector optically connects LC fiber internal module duplex 4 side a to the yellow MTP port of the first LC connector;
the eighth internal light path of the first LC connector optically connects LC fiber internal module duplex 4 side b to the brown MTP port of the first LC connector;
the ninth internal light path of the first LC connector optically connects LC fiber internal module duplex 5 side a to the black MTP port of the first LC connector;
the tenth internal light path of the first LC connector optically connects LC fiber internal module duplex 5 side b to the slate MTP port of the first LC connector;
the eleventh internal light path of the first LC connector optically connects LC fiber internal module duplex 6 side a to the red MTP port of the first LC connector; and
the twelfth internal light path of the first LC connector optically connects LC fiber internal module duplex 6 side b to the white MTP port of the first LC connector.

19. The assembly of claim 18 wherein:
the second LC connector further comprises first to twelfth LC internal light paths;
the first internal light path of the second LC connector optically connects LC fiber internal module duplex 1 side a to the aqua MTP port of the second LC connector;
the second internal light path of the second LC connector optically connects LC fiber internal module duplex 1 side b to the blue MTP port of the second LC connector;
the third internal light path of the second LC connector optically connects LC fiber internal module duplex 2 side a to the pink MTP port of the second LC connector;
the fourth internal light path of the second LC connector optically connects LC fiber internal module duplex 2 side b to the orange MTP port of the second LC connector;
the fifth internal light path of the second LC connector optically connects LC fiber internal module duplex 3 side a to the purple MTP port of the second LC connector;
the sixth internal light path of the second LC connector optically connects LC fiber internal module duplex 3 side b to the green MTP port of the second LC connector;
the seventh internal light path of the second LC connector optically connects LC fiber internal module duplex 4 side a to the yellow MTP port of the second LC connector;
the eighth internal light path of the second LC connector optically connects LC fiber internal module duplex 4 side b to the brown MTP port of the second LC connector;
the ninth internal light path of the second LC connector optically connects LC fiber internal module duplex 5 side a to the black MTP port of the second LC connector;
the tenth internal light path of the second LC connector optically connects LC fiber internal module duplex 5 side b to the slate MTP port of the second LC connector;
the eleventh internal light path of the second LC connector optically connects LC fiber internal module duplex 6 side a to the red MTP port of the second LC connector; and
the twelfth internal light path of the second LC connector optically connects LC fiber internal module duplex 6 side b to the white MTP port of the second LC connector.

20. The assembly of claim 18 further comprising:
a first set of six LC duplex modules; and
a second set of six LC duplex modules; wherein:
the first set of six LC duplex modules are each optically connected to the first LC connector; and
the second set of six LC duplex modules are each optically connected to the second LC connector.
